(19) United States
(12) Patent Application Publication
(10) Pub. No.: US 2024/0383747 A1
(43) Pub. Date: Nov. 21, 2024

(54) GASEOUS FUEL PRODUCTION SYSTEM

(71) Applicant: NATIONAL CHENG KUNG UNIVERSITY, Tainan City (TW)

(72) Inventor: Wei-Cheng WANG, Tainan City (TW)

(21) Appl. No.: 18/473,508

(22) Filed: Sep. 25, 2023

(30) Foreign Application Priority Data
May 18, 2023 (TW) 112118476

(51) Int. Cl. C01B 3/22

(52) U.S. Cl. CPC C01B 3/22; C01B 2203/043; C01B 2203/0475; C01B 2203/1657

(57) ABSTRACT

A gaseous fuel production system is adapted for producing a gaseous fuel from an object, and includes at least two adsorbing devices, a mixture space, a first detector, an air extractor pump, and a second detector. The at least two adsorbing devices are adapted for adsorbing a target gas. Each of the mixture space and the air extractor pump is connected downstream of the at least two adsorbing devices. Each of the at least two adsorbing devices is convertible between an adsorbing state, in which the adsorbing device adsorbs the target gas and the first detector measures a first concentration of the target gas in the mixture space, and a desorption state, in which the target gas is extracted from the adsorbing device by the air extractor pump and the second detector measures a second concentration of the target gas in a fluid located downstream of the air extractor pump.

### CROSS-REFERENCE TO RELATED APPLICATION

This application claims priority to Taiwanese Invention patent application No. 112118476, filed on May 18, 2023.

### FIELD

The present disclosure relates to a production system, and more particularly to a gaseous fuel production system.

### BACKGROUND

In a conventional thermal decomposition process, waste may at least partially be converted into usable gases, such as hydrogen gas and oxygen gas that can produce energy when burned. Thus, the waste may be reprocessed. Specifically, the waste contains large molecules that include carbon atoms, hydrogen atoms, and oxygen atoms, and the waste undergoes thermal decomposition so that the large molecules decompose, thereby producing the usable gases.

However, because the molecules in the waster are large, the carbon atoms that account for a large portion of each of the large molecules are prone to forming carbon dioxide molecules or hydrocarbon compounds with hydrogen atoms and oxygen atoms. The carbon dioxide molecules and hydrocarbon compounds are unwanted products, and have to undergo an extra process to avoid carbon emissions and environmental pollution. The production of the carbon dioxide molecules and hydrocarbon compounds reduces the maximum amount of usable gases that can be produced via the conventional thermal decomposition process. That is to say, the quality of the usable gases produced via the conventional thermal decomposition process may be poor, and the production efficiency of the conventional thermal decomposition process may be low.

### SUMMARY

Therefore, an object of the disclosure is to provide a gaseous fuel production system that can alleviate at least one of the drawbacks of the prior art.

According to the disclosure, the gaseous fuel production system is adapted for producing a gaseous fuel from an object. The gaseous fuel production system includes a gasification unit and a purification unit. The gasification unit includes a furnace, an object-feeding subunit, a gas inlet subunit, and a conversion subunit. The furnace defines a processing space. The object-feeding subunit is connected to the furnace, and is adapted for feeding the object into the processing space. The gas inlet subunit is connected to the furnace, and is adapted for introducing at least one auxiliary gas into the processing space. The conversion subunit is connected downstream of the furnace, and defines a processing chamber that is in spatial communication with the processing space and that is adapted for accommodating plasma. The purification unit is connected downstream of the gasification unit, and includes at least two adsorbing devices, a mixture space, a first detector, an air extractor pump, a second detector, and an electric control subunit. The at least two adsorbing devices are connected in parallel and are adapted for adsorbing a target gas. The mixture space is connected downstream of the at least two adsorbing devices. The air extractor pump is connected downstream of the at least two adsorbing devices. The electric control subunit is signally connected to the first detector and the second detector. Each of the at least two adsorbing devices is convertible between an adsorbing state, in which fluid communication between the adsorbing device and the gasification unit is permitted, fluid communication between the adsorbing device and the mixture space is permitted and fluid communication between the adsorbing device and the air extractor pump is prevented so that the adsorbing device adsorbs the target gas and that the first detector measures a first concentration of the target gas in the mixture space, and a desorption state, in which the fluid communication between the adsorbing device and the air extractor pump is permitted, the fluid communication between the adsorbing device and the mixture space is prevented and the fluid communication between the adsorbing device and the gasification unit is prevented so that the target gas is extracted from the adsorbing device by the air extractor pump and that the second detector measures a second concentration of the target gas in a fluid located downstream of the air extractor pump. When the purification unit is in operation, all of the at least two adsorbing devices are not simultaneously in the desorption state. When the second concentration of the target gas in the fluid located downstream of the air extractor pump measured by the second detector is lower than a desorption default value, the electric control subunit sets at least one of the at least two adsorbing devices to be in the adsorbing state. When the first concentration of the target gas in the mixture space measured by the first detector is higher than an adsorbing default value, the electric control subunit converts one of the at least two adsorbing devices that are in the adsorbing state into the desorption state.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view of an embodiment of a gaseous fuel production system according to the disclosure.

FIG. 2 is a schematic view of a gasification unit of the embodiment.

FIG. 3 is a perspective view of a swirler of a gas inlet subunit of the gasification unit.

FIG. 4 is a sectional view of a conversion subunit of the gasification unit.

FIG. 5 is a schematic view illustrating one of adsorbing devices of a purification unit of the embodiment in an adsorbing state and the other one of the adsorbing devices of the purification unit in an desorption state.

FIG. 6 is a view similar to FIG. 5, but illustrating the one of the adsorbing devices in the desorption state and the other one of the adsorbing devices in the adsorbing state.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

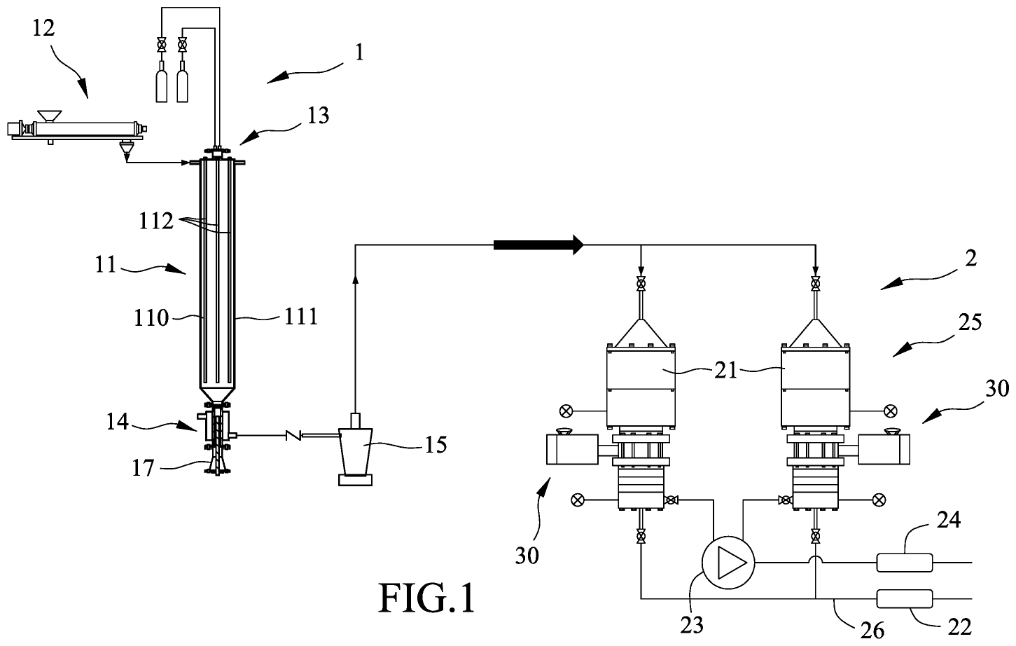

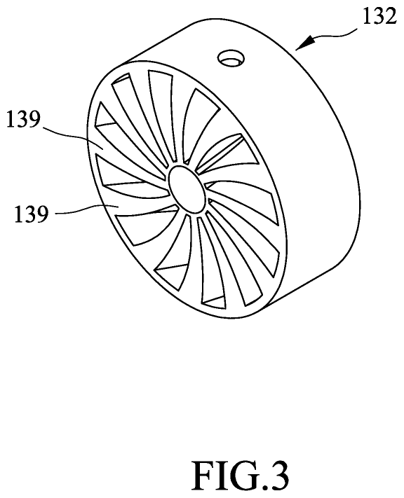

Referring to FIGS. 1 to 3, an embodiment of a gaseous fuel production system according to the disclosure is adapted for producing a purified gas from an object. The purified gas serves as a gaseous fuel, and will thus be referred to as “the gaseous fuel.” The object is mixed with at least one auxiliary gas in the gaseous fuel production system. In this embodiment, the object may be organic waste that contains carbon atoms, hydrogen atoms, and oxygen atoms, and the gaseous fuel may be hydrogen gas. The at least one auxiliary gas may be a carrier fluid in thermal decomposition that occurs in the gaseous fuel production system. In this embodiment, the at least one auxiliary gas includes two auxiliary gases that are, for example, oxygen gas and carbon dioxide gas. However, in certain embodiments, the object and the at least one auxiliary gas may be objects or gases other than those mentioned in the above examples. The gaseous fuel production system includes a gasification unit 1, and a purification unit 2 that is connected downstream of the gasification unit 1.

The gasification unit 1 includes a furnace 11, an object-feeding subunit 12, a gas inlet subunit 13, a conversion subunit 14, a cyclone separator 15, and a collection tank 17. The furnace 11 defines a processing space 110. The object-feeding subunit 12 is connected to the furnace 11 and is adapted for feeding the object into the processing space 110. The gas inlet subunit 13 is connected to the furnace 11, and is adapted for introducing the auxiliary gases into the processing space 110. Specifically, the gas inlet subunit 13 is connected upstream of the furnace 11. The conversion subunit 14 is connected downstream of the furnace 11. The cyclone separator 15 is connected downstream of the conversion subunit 14. When the gasification unit 1 is in operation, the conversion subunit 14 is adapted for generating an air stream with particulates, and the cyclone separator 15 is adapted for separating the particulates from the air stream. The collection tank 17 is disposed below the conversion subunit 14, and is adapted for collecting ash.

The furnace 11 includes a main body 111 that defines the processing space 110, and a plurality of heaters 112 that are disposed in the processing space 110 and that are adapted for generating thermal decomposition. The gas inlet subunit 13 includes an inlet body 131 that defines an introducing chamber 130, and a swirler 132 that is disposed in the introducing chamber 130 and that is connected upstream of the object-feeding subunit 12. The swirler 132 surrounds a swirler axis and has a plurality of vanes 139 that are arranged around the swirler axis. Each of the vanes 139 substantially extends in a radial direction of the swirler 132. In this embodiment, each of the vanes 139 is curved. In order to reduce energy consumption, the swirler 132 is fixedly disposed in the introducing chamber 130. When the auxiliary gases are fed into the introducing chamber 130, by virtue of the vanes 139, the swirler 132 may introduce the auxiliary gases into the processing space 110 via a vortex. Since the swirler 132 is not rotatable, there is no need to input additional energy to rotate the swirler 132. By virtue of the swirler 132 introducing the auxiliary gases into the processing space 110, the auxiliary gases may serve as carrier gases that urge the object in the processing space 110 to move, and the object may be well mixed with the auxiliary gases so that the efficiency of the thermal decomposition that occurs in the processing space 110 may be improved (i.e., the object may efficiently be decomposed in the processing space 110).

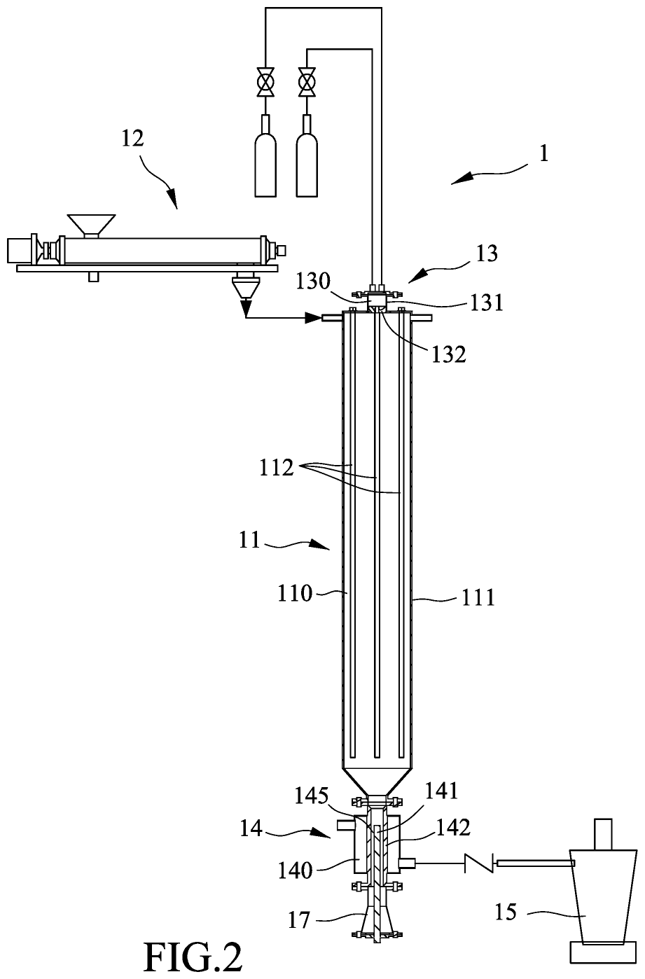

It is noted that, in FIGS. 1 and 2, the furnace 11, the conversion subunit 14, and the collection tank 17 are depicted in sectional views in order to clearly show inner structures thereof.

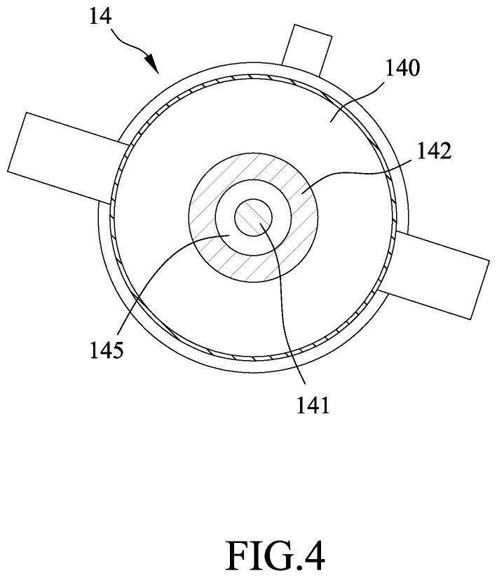

Referring further to FIG. 4, the conversion subunit 14 defines a processing chamber 140 that is in spatial communication with the processing space 110 and that is adapted for accommodating plasma. The conversion subunit 14 includes a positive electrode 141 and a negative electrode 142. The positive electrode 141 extends along an imaginary axis (not shown), and extends into the processing chamber 140. The negative electrode 142 surrounds the positive electrode 141, extends in an extending direction of the imaginary axis, and is spaced apart from the positive electrode 141 in a radial direction thereof such that the positive electrode 141 and the negative electrode 142 cooperatively define a gas channel 145 therebetween. The heaters 112 heat a mixture of the object and the auxiliary gases in the processing space 110 so that the object undergoes the thermal decomposition in the processing space 110. Then, the object enters the processing chamber 140. At this time, the positive electrode 141 and the negative electrode 142 cooperatively generate electric arcs via high-voltage power supply therebetween so that the plasma is generated in the processing chamber 140. Some substances (e.g., tar) of the object that are not decomposed in the processing space 110 are thus converted into different substances that may be used to produce hydrogen gas in the processing chamber 140. The collection tank 17 is disposed below the gas channel 145 so that the remaining substances of the object that are not converted by the plasma in the gas channel 145, that have no calorific value, and that have become high-density ash/fly ash may fall into the collection tank 17. In addition, because the conversion subunit 14 generates the air stream with the particulates that have not fallen into the collection tank 17, the cyclone separator 15 is operable to separate the particulates from the air stream through vortex separation. Specifically, solids and liquids may be separated from the air stream so that gases that are introduced to any devices connected downstream of the gasification unit 1 may be free of any liquid or solid particles that will affect a following purification process.

Referring to FIG. 1 again, the purification unit 2 includes two adsorbing devices 21, a first detector 22, an air extractor pump 23, a second detector 24, an electric control subunit 25, and a mixture space 26. The adsorbing devices 21 are connected in parallel and are adapted for adsorbing a target gas. The mixture space 26 is connected downstream of the adsorbing devices 21. The first detector 22 is connected downstream of the mixture space 26. The air extractor pump 23 is connected downstream of the adsorbing devices 21. The second detector 24 is connected downstream of the air extractor pump 23. The electric control subunit 25 is signally connected to the first detector 22 and the second detector 24. Each of the adsorbing devices 21 is convertible between an adsorbing state, in which fluid communication between the adsorbing device 21 and the gasification unit 1 is permitted, fluid communication between the adsorbing device 21 and the mixture space 26 is permitted and fluid communication between the adsorbing device 21 and the air extractor pump 23 is prevented so that the adsorbing device 21 adsorbs the target gas and that the first detector 22 measures a first concentration of the target gas in the mixture space 26, and a desorption state, in which the fluid communication between the adsorbing device 21 and the air extractor pump 23 is permitted, the fluid communication between the adsorbing device 21 and the mixture space 26 is prevented and the fluid communication between the adsorbing device 21 and the gasification unit 1 is prevented so that the target gas is extracted from the adsorbing device 21 by the air extractor pump 23 and that the second detector 24 measures a second concentration of the target gas in a fluid located downstream of the air extractor pump 23. In this embodiment, because the object is organic waste that contains carbon atoms, hydrogen atoms, and oxygen atoms, the thermal decomposition and the conversion of the object both generate carbon dioxide gas, which is an unwanted product. Therefore, the carbon dioxide gas is the target gas that has to be separated. In addition, each of the first detector 22 and the second detector 24 of the purification unit 2 is configured to be a gas detector that is operable to measure a concentration of carbon dioxide.

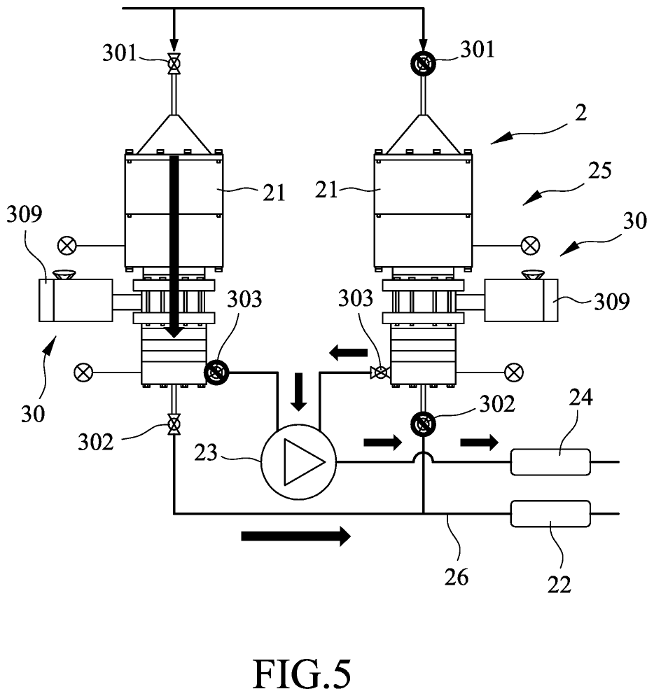

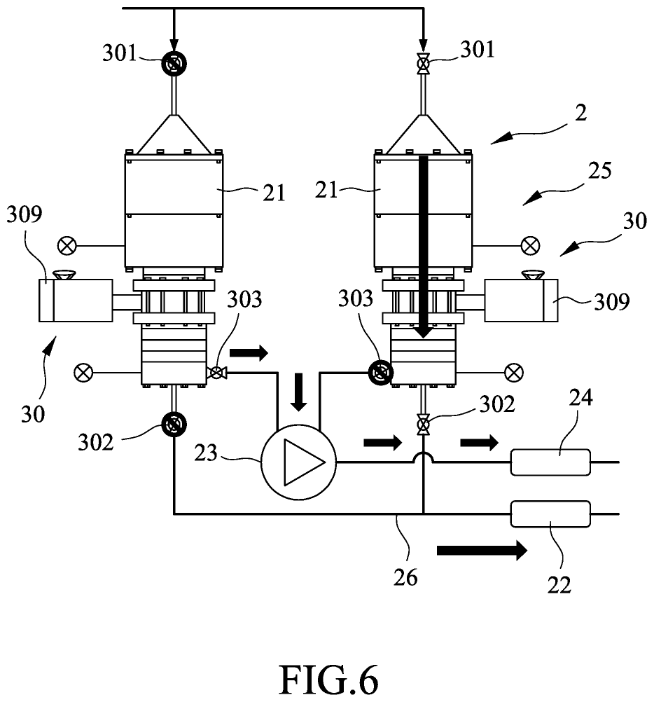

Referring further to FIGS. 5 and 6, in order to produce hydrogen gas with higher quality, carbon dioxide gas has to be separated from gases that are produced in the gasification unit 1 and that are introduced into the purification unit 2 (i.e., the gases that are produced in the gasification unit 1 have to be purified in the purification unit 2). Specifically, each of the adsorbing devices 21 includes a solid adsorbent that is capable of adsorbing carbon dioxide. When one of the adsorbing devices 21 is in the adsorbing state, the gases that are produced in the gasification unit 1 and that include the carbon dioxide gas are introduced into the one of the adsorbing devices 21 by the cyclone separator 15, and then the carbon dioxide gas thereof is adsorbed by the one of the adsorbing devices 21. Thus, high-purity hydrogen gas (i.e., the gaseous fuel) is produced by the purification unit 2, and may be collected through pipes that are connected downstream of the adsorbing devices 21 for future use.

It is noted that, in order to ensure that the gaseous fuel may be produced without interruption, and that the carbon dioxide gas may be continuously adsorbed, when the purification unit 2 is in operation, all of the adsorbing devices 21 are not simultaneously in the desorption state. Because the solid adsorbent of each of the adsorbing devices 21 has its own adsorption capacity, when the amount of the carbon dioxide gas adsorbed by one of the adsorbing devices 21 reaches the adsorption capacity of the solid adsorbent of the one of the adsorbing devices 21, the other one of the adsorbing devices 21 has to adsorb the carbon dioxide gas so that adsorption of the carbon dioxide gas may not be interrupted, and the carbon dioxide gas has to be extracted from the one of the adsorbing devices 21 at the same time. Therefore, when the second concentration of the target gas in the fluid located downstream of the air extractor pump 23 measured by the second detector 24 is lower than a desorption default value, the electric control subunit 25 sets at least one of the adsorbing devices 21 to be in the adsorbing state. When the first concentration of the target gas in the mixture space 26 measured by the first detector 22 is higher than an adsorbing default value, the electric control subunit 25 converts one of the adsorbing devices 21 that are in the adsorbing state into the desorption state. The electric control subunit 25 includes two conversion mechanisms 30 that are respectively disposed on the adsorbing devices 21. Each of the conversion mechanism 30 includes an inlet valve 301 that interconnects the gasification unit 1 and the respective one of the adsorbing devices 21, an outlet valve 302 that interconnects the mixture space 26 and the respective one of the adsorbing devices 21, a suction valve 303 that interconnects the air extractor pump 23 and the respective one of the adsorbing devices 21, and a control member 309 that is operable to urge each of the inlet valve 301, the outlet valve 302, and the suction valve 303 to open or close.

For each of the adsorbing devices 21, when in the adsorbing state, the inlet valve 301 and the outlet valve 302 of the respective one of the conversion mechanisms 30 are open and the suction valve 303 of the respective one of the conversion mechanisms 30 is closed, and when in the desorption state, the inlet valve 301 and the outlet valve 302 of the respective one of the conversion mechanisms 30 are closed and the suction valve 303 of the respective one of the conversion mechanisms 30 is open. The first detector 22 continuously measures the first concentration of the target gas in the mixture space 26, and the second detector 24 continuously measures the second concentration of the target gas in the fluid located downstream of the air extractor pump 23. Referring to FIG. 5 again, when the first concentration of the target gas in the mixture space 26 measured by the first detector 22 is higher than the adsorbing default value, the electric control subunit 25 converts the adsorbing device 21 on the right side of FIG. 5 from the adsorbing state into the desorption state. At this time, the inlet valve 301 and the outlet valve 302 on the right side are closed and the suction valve 303 on the right side is open so that the air extractor pump 23 may extract the carbon dioxide gas from the adsorbing device 21 on the right side and that the second detector 24 may measure the second concentration of the carbon dioxide gas in the fluid located downstream of the air extractor pump 23 to track extraction of the carbon dioxide gas in the adsorbing device 21 on the right side. Because the adsorbing devices 21 are not simultaneously in the desorption state, the adsorbing device 21 on the left side of FIG. 5 is now set by the electric control subunits 25 to be in the adsorbing state. The inlet valve 301 and the outlet valve 302 on the left side are open and the suction valve 303 on the left side is closed so that the adsorbing device 21 on the left side may adsorb the carbon dioxide gas.

Referring to FIG. 6 again, afterwards, when the first concentration of the target gas in the mixture space 26 measured by the first detector 22 is close to the adsorbing default value, and when the second concentration of the target gas in the fluid located downstream of the air extractor pump 23 measured by the second detector 24 is lower than the desorption default value, the electric control subunit 25 converts the adsorbing device 21 on the right side of FIG. 6 from the desorption state into the adsorbing state, and then converts the adsorbing device 21 on the left side of FIG. 6 from the adsorbing state into the desorption state (i.e., the states of the adsorbing devices 21 in FIGS. 5 and 6 are reversed). Therefore, the adsorption of the carbon dioxide gas is not interrupted, and when the carbon dioxide gas is extracted from the adsorbing device on the left side of FIG. 6, the adsorbing device on the left side may be ready for adsorbing the carbon dioxide gas again.

Moreover, when there is a larger amount of the target gas that has to be adsorbed, in one embodiment, the purification unit 2 may include more than two adsorbing devices 21 to provide enough adsorption capacity and to ensure that the gaseous fuel production system may not malfunction. In that case, the electric control subunit 25 may include more than two conversion mechanisms 30 that are respectively disposed on the adsorbing devices 21 (i.e., the number of conversion mechanisms 30 is the same as that of the adsorbing devices 21). Each of the conversion mechanisms 30 is operable to convert the respective one of the adsorbing devices 21 so that all of the adsorbing devices 21 are not simultaneously in the desorption state and that more than one adsorbing device 21 may be simultaneously in the adsorbing state. Therefore, it will not be a race against time to extract the carbon dioxide gas from one of the adsorbing devices 21 that is in the desorption state. Advantages of including more than two adsorbing devices 21 may thus be exploited.

In summary, by virtue of the thermal decomposition and the plasma in the gasification unit 1, as much hydrogen gas is generated as possible from the object. By virtue of the adsorbing devices 21 not being simultaneously in the desorption state, the adsorption of the carbon dioxide gas is not interrupted. Therefore, no extra process is needed for avoiding carbon emissions. The quality of the produced gaseous fuel may be relatively high, and the efficiency of gaseous fuel production system may be improved. Thus, the purpose of the disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A gaseous fuel production system adapted for producing a gaseous fuel from an object, said gaseous fuel production system comprising:
a gasification unit including a furnace that defines a processing space, an object-feeding subunit that is connected to said furnace and that is adapted for feeding the object into said processing space, a gas inlet subunit that is connected to said furnace and that is adapted for introducing at least one auxiliary gas into said processing space, and a conversion subunit that is connected downstream of said furnace, and that defines a processing chamber which is in spatial communication with said processing space and which is adapted for accommodating plasma; and
a purification unit connected downstream of said gasification unit, and including at least two adsorbing devices that are connected in parallel and that are adapted for adsorbing a target gas, a mixture space that is connected downstream of said at least two adsorbing devices, a first detector that is connected downstream of said mixture space, an air extractor pump that is connected downstream of said at least two adsorbing devices, a second detector that is connected downstream of said air extractor pump, and an electric control subunit that is signally connected to said first detector and said second detector, each of said at least two adsorbing devices being convertible between an adsorbing state, in which fluid communication between said adsorbing device and said gasification unit is permitted, fluid communication between said adsorbing device and said mixture space is permitted and fluid communication between said adsorbing device and said air extractor pump is prevented so that said adsorbing device adsorbs the target gas and that said first detector measures a first concentration of the target gas in said mixture space, and a desorption state, in which the fluid communication between said adsorbing device and said air extractor pump is permitted, the fluid communication between said adsorbing device and said mixture space is prevented and the fluid communication between said adsorbing device and said gasification unit is prevented so that the target gas is extracted from said adsorbing device by said air extractor pump and that said second detector measures a second concentration of the target gas in a fluid located downstream of said air extractor pump;
wherein, when said purification unit is in operation, all of said at least two adsorbing devices are not simultaneously in the desorption state;
wherein, when the second concentration of the target gas in the fluid located downstream of said air extractor pump measured by said second detector is lower than a desorption default value, said electric control subunit sets at least one of said at least two adsorbing devices to be in the adsorbing state; and
wherein, when the first concentration of the target gas in said mixture space measured by said first detector is higher than an adsorbing default value, said electric control subunit converts one of said at least two adsorbing devices that are in the adsorbing state into the desorption state.

2. The gaseous fuel production system as claimed in claim 1, wherein said gasification unit further includes a cyclone separator that is connected downstream of said conversion subunit, when said gasification unit is in operation, said conversion subunit being adapted for generating an air stream with particulates, and the cyclone separator being adapted for separating the particulates from the air stream.

3. The gaseous fuel production system as claimed in claim 1, wherein said gas inlet subunit of said gasification unit includes an inlet body that defines an introducing chamber, and a swirler that is disposed in said introducing chamber and that is adapted for introducing the at least one auxiliary gas into said processing space via a vortex.

4. The gaseous fuel production system as claimed in claim 3, wherein said swirler of said gas inlet subunit surrounds a swirler axis and has a plurality of vanes that are arranged around the swirler axis, each of the vanes substantially extending in a radial direction of said swirler.

5. The gaseous fuel production system as claimed in claim 1, wherein said furnace of said gasification unit includes a main body that defines said processing space, and at least one heater that is disposed in said processing space.

6. The gaseous fuel production system as claimed in claim 1, wherein said conversion subunit of said gasification unit includes a positive electrode that extends along an imaginary axis, and a negative electrode that surrounds said positive electrode, that extends in an extending direction of the imaginary axis, and that is spaced apart from said positive electrode in a radial direction thereof such that said positive electrode and said negative electrode cooperatively define a gas channel therebetween.

7. The gaseous fuel production system as claimed in claim 6, wherein said gasification unit further includes a collection tank that is disposed below said gas channel and that is adapted for collecting ash.

8. The gaseous fuel production system as claimed in claim 1, wherein said electric control subunit of said purification unit includes at least two conversion mechanisms that are respectively disposed on said at least two adsorbing devices, each of said at least two conversion mechanism including an inlet valve that interconnects said gasification unit and the respective one of said at least two adsorbing devices, an outlet valve that interconnects said mixture space and the respective one of said at least two adsorbing devices, a suction valve that interconnects said air extractor pump and the respective one of said at least two adsorbing devices, and a control member that is operable to urge each of said inlet valve, said outlet valve, and said suction valve to open or close, for each of said at least two adsorbing devices, when in the adsorbing state, said inlet valve and said outlet valve of the respective one of said conversion mechanisms being open and said suction valve of the respective one of said conversion mechanisms being closed, and when in the desorption state, said inlet valve and said outlet valve of the respective one of said conversion mechanisms being closed and said suction valve of the respective one of said conversion mechanisms being open.

9. The gaseous fuel production system as claimed in claim 1, wherein each of said first detector and said second detector of said purification unit is configured to be a gas detector that is operable to measure a concentration of carbon dioxide.
